(19) United States
(12) Patent Application Publication
(10) Pub. No.: US 2012/0180326 A1
(43) Pub. Date: Jul. 19, 2012

(54) CUTTER HEAD FOR PAPER CUTTER

(76) Inventors: Jin-Song WU, Guangdong (CN); Ye Ma, Guangdong (CN)

(21) Appl. No.: 13/213,759

(22) Filed: Aug. 19, 2011

(30) Foreign Application Priority Data
Jan. 17, 2011 (CN) 201120018628.6

(51) Int. Cl. B26B 5/00

(52) U.S. Cl. 30/337

(57) ABSTRACT

A cutter head riveted to a cutter handle of a paper cutter and made by stamping a stainless steel plate into shape is disclosed, having a locking key on a middle part of a back side thereof for locking an inserted cutter blade. The locking key is a self-energizing resilient member having a locking portion for engaging into a locating notch in the top edge of the inserted cutter blade.

### BACKGROUND OF THE INVENTION

1. Field of the Invention

The present invention relates to metal cutter fabrication technology and more particularly, to a new design of cutter head for paper cutter.

2. Description of the Related Art

The cutter head for paper cutter according to conventional designs may be formed of a plurality of stainless steel blades arranged in a stack. In some other designs, the cutter head can be a cast member. Conventional paper cutters using a cutter head of either of the aforesaid two designs commonly have the drawbacks of high manufacturing cost, complicated manufacturing process, heavy cutter head and inconvenience of use.

Therefore, it is desirable to provide a cutter head for paper cutter, which eliminates the aforesaid drawbacks.

### SUMMARY OF THE INVENTION

The present invention has been accomplished to eliminate the drawbacks of the aforesaid prior art designs. It is the main object of the present invention to provide a cutter head for paper cutter, which has the characteristics of simple and compact design, convenient for use and low manufacturing cost.

To achieve this and other objects of the present invention, a cutter head for paper cutter is riveted to a cutter handle. The cutter head is made by stamping a stainless steel plate into shape comprising a locking key on a middle part of a back side thereof for locking the inserted cutter blade.

Further, the locking key is a self-energizing resilient member comprising a locking portion for engaging into a locating notch in the top edge of the cutter blade.

Further, the cutter head defines therein an accommodation chamber for accommodating a cutter blade. When the cutter blade is inserted into the accommodation chamber of the cutter head, the locking portion of the locking key will automatically engages the locating notch of the cutter blade, thereby locking the cutter blade. When wishing to replace the cutter blade, operate a control button to disengage the locking portion of the locking key from the locating notch of the cutter blade, and then take the cutter blade out of the cutter head.

When compared to the conventional techniques, the invention has the advantages as follows:

The cutter head is made by stamping a stainless steel plate into shape. This fabrication method is simple, shortening much the fabrication time. The cutter head thus made has the characteristics of light weight, simple structure and low manufacturing cost, and therefore the invention has a high industrial value.

### BRIEF DESCRIPTION OF THE DRAWINGS

FIG. 1 is a schematic drawing illustrating the outer appearance of a cutter head for paper cutter in accordance with the present invention.

FIG. 2 is a schematic drawing of the present invention, illustrating a cutter head riveted to a cutter handle and held in the extended position.

FIG. 3 is a schematic drawing of the present invention, illustrating a cutter blade inserted into the cutter head.

FIG. 4 is a schematic drawing of the present invention, illustrating the cutter blade removed from the cutter head.

FIG. 5 is a schematic drawing of the present invention, illustrating the relationship between the locking portion of the locking key and the locating notch of the cutter blade.

FIG. 6 is a schematic drawing of the present invention, illustrating the cutter blade installed in the cutter head and the cutter head extended out of the cutter handle.

### DETAILED DESCRIPTION OF THE INVENTION

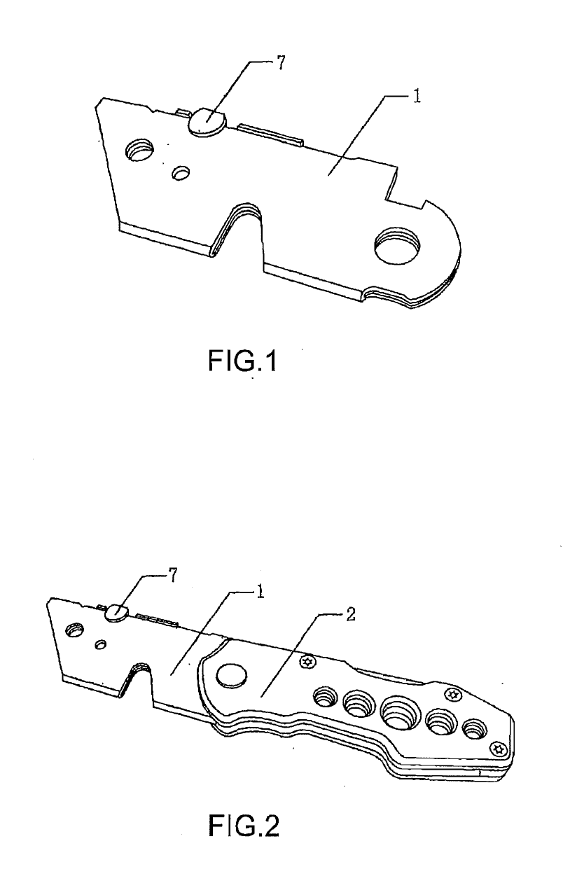

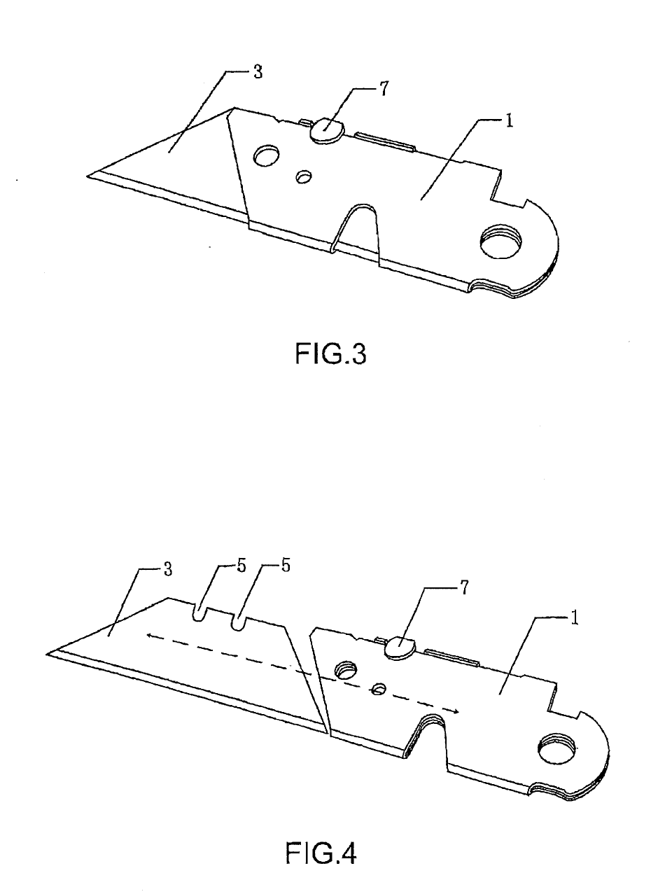

As shown in FIGS. 1-6, a cutter head 1 is riveted to a cutter handle 2. The cutter head 1 has a back side and a front side. The cutter head 1 is made by stamping a stainless steel plate into shape, defining therein an accommodation chamber for accommodating a cutter blade 3 and a locking key 4 on a middle part of the back side thereof for locking the cutter blade 3. The locking key 4 is an integrated part of the cutter head 1.

The locking key 4 is a self-energizing resilient member, comprising a locking portion 6 and a control button 7. The locking portion 6 is matching a locating notch 5 in the top edge of the cutter blade 3. The control button 7 bends forward to the front side of the cutter head 1.

The cutter blade installation flow of the invention is outlined hereinafter.

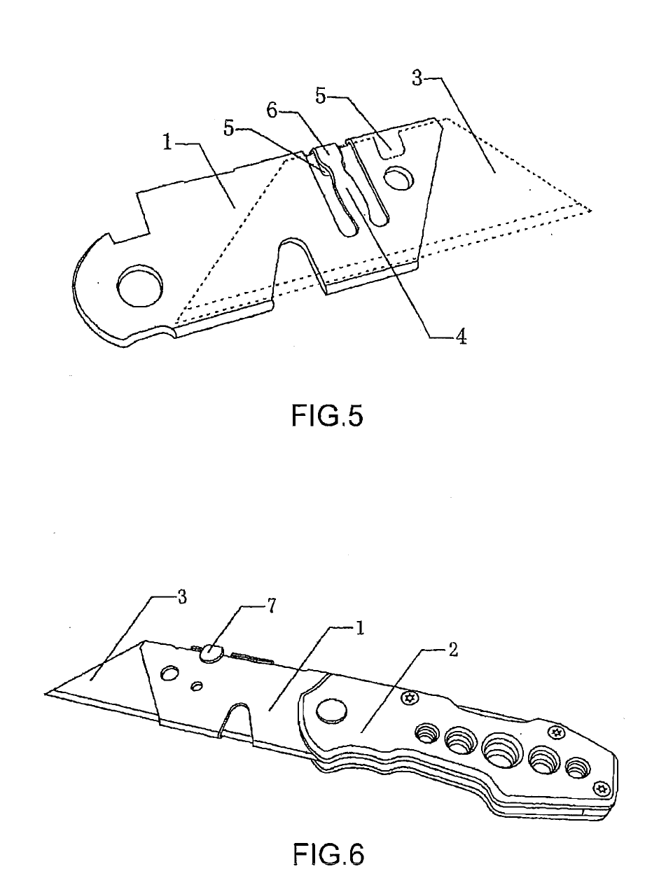

When using the present invention, extend the cutter head 1 out of the cutter handle 2, as shown in FIG. 2, and then push the control button, referenced by 7, to the back side, and then attach the cutter blade 3 into the accommodation chamber in the cutter head 1, as shown in FIG. 4, and then release the control button 7 after insertion of the cutter blade 3 into the cutter head 1, as shown in FIG. 5. At this time, the locking portion 6 of the locking key 4 is automatically forced by its resilient material property into engagement with the locating notch 5 that is provided in the top edge of the cutter blade 3, locking the cutter blade 3 to the cutter head 1, as shown in FIG. 6. When wishing to remove the cutter blade 3 from the cutter head 1, push the control button 7 to move the locking portion 6 away from the locating notch 5, and take the cutter blade 3 away from the cutter head 1.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A cutter head (1) riveted to a cutter handle (2), wherein said cutter head (1) has a back side and a front side and is made by stamping a stainless steel plate into shape, defining therein an accommodation chamber for accommodating a cutter blade (3) and comprising a locking key (4) on a middle part of the back side thereof for locking the inserted cutter blade (3).

2. The cutter head (1) as claimed in claim 1, wherein said locking key (4) has a locking portion (6) and a control button (7), said locking key (4) is a self-energizing resilient member comprising a locking portion (6) for engaging into a locating notch (5) in the top edge of the cutter blade (3), and the control button (7) bends forward to the front side of the cutter head (1).
